(19) United States
(12) Patent Application Publication
(10) Pub. No.: US 2022/0161733 A1
(43) Pub. Date: May 26, 2022

(54) Vehicle Mounted Bike Rack

(71) Applicant: Curt Manufacturing, LLC, Eau Claire, WI (US)

(72) Inventors: Curtis M. Bowe, Chippewa Falls, WI (US); Joel D. Diller, Eau Claire, WI (US); Brandon A. Knuth, Eau Claire, WI (US); Graham A. Motzing, Eau Claire, WI (US)

(21) Appl. No.: 17/535,355

(22) Filed: Nov. 24, 2021

Related U.S. Application Data
(60) Provisional application No. 63/117,737, filed on Nov. 24, 2020.

(51) Int. Cl. B60R 9/06; B60R 9/10; B60D 1/52

(52) U.S. Cl. CPC B60R 9/06; B60D 1/52; B60R 9/10

(57) ABSTRACT

A bike rack is mountable from a traditional receiver hitch and utilizes at least one of the two pedal crank arms of the bike for securing and supporting the bike. The pedal crank arm is received in a pedal crank receiver which tightens to the pedal crank arm and holds the pedal crank arm in a set rotational position. The pedal crank receiver is connected to a main shank of the bike rack for supporting the weight of the bike from the receiver hitch. The bike rack also includes a cradle supporting the bottom bracket shell of the bike, and a second support structure which holds the bike at a location spaced from the pedal crank receiver, both connected to the main shank.

### CROSS-REFERENCE TO RELATED APPLICATION(S)

The present application claims priority from U.S. Provisional Application No. 63/117,737 entitled VEHICLE MOUNTED BIKE RACK filed Nov. 24, 2020, incorporated herein by reference.

### BACKGROUND OF THE INVENTION

The present application relates to bike racks, and particularly to bike racks which are mounted from a vehicle, such as in a hitch receiver used for towing loads off the back of the towing vehicle. U.S. Pat. Nos. 5,025,932, 5,476,203, 5,947,357, 6,626,340, 6,951,287, 9,555,744, and 9,840,855 show prior art vehicle mounted bike racks, and are all incorporated by reference for their teaching of the problems and mounting environment.

FIG. 1 shows a common frame style used on bikes, presented to identify nomenclature used on different frame parts. In particular, this bike 10 includes a frame 12 with three primary metal tubular parts which generally form a triangle: a toptube 14, a seat tube 16 and a downtube 18. The toptube 14 and the downtube 18 are each welded to a headtube 20 at their front ends. The downtube 18 and the seat tube 16 are welded to a bottom bracket shell 22 at their lower ends. The rear end of the toptube 14 is welded to an upper end of the seat tube 16. The front wheel 24 supports a front fork 26 which pivots within the headtube 20 as controlled by the handlebars 28 to allow steering of the bike 10. The rear wheel 30 supports the frame 12 at two dropouts 32. A chainstay 34 connects each rear dropout 32 to the bottom bracket shell 22, and a seatstay 36 connects each rear dropout 32 to the top of the seat tube 16. The rear wheel 30 is chain driven by pedaling using the two pedals 38, each supported by a pedal crank arm 40. The two pedal crank arms 40 are rigidly connected with a pedal crank axle 42 extending through the bottom bracket shell 22, for rotation of a front sprocket 44 about the horizontal axis 46 established by the bottom bracket shell 22. The chain 48 then transfers torque from the front sprocket 44 to the rear sprocket 50, with the rear sprocket 50 attached (at least in the forward direction) to the rear wheel 30, to drive the bike 10.

A generalize primary question with regard to any vehicle mounted bike rack is where on such a bicycle 10 are the support forces going to be applied to hold the bike 10 in position during vehicle travel. A few prior art bike racks, such as those disclosed in U.S. Pat. Nos. 5,025,932, 5,947,357 and 6,626,340, make use of the pedal crank arm to hold the bike in position. However, these prior art bike racks do not hold the bike sufficiently securely for widespread adoption.

Vehicle mounted bike racks should be easy to use, both in attaching and detaching the bike rack to and from the towing vehicle, and in attaching and detaching the bike to the bike rack. Vehicle mounted bike racks should be strong and secure for support of the bike(s) while minimizing the possibilities of damage to the bike(s), providing sufficient clearance between the bike and the towing vehicle to avoid contact during towing as well as during mounting and dismounting the bike from the bike rack. Vehicle mounted bike racks should be robust for a long product life, while still being light in weight and low in cost. Better vehicle mounted bike rack solutions are needed.

### BRIEF SUMMARY OF THE INVENTION

The present invention is a bike rack mountable from a traditional receiver hitch that utilizes at least one of the two pedal crank arms of the bike for securing and supporting the bike, as well as a method of using the bike rack. The bike rack has a pedal crank receiver which tightens to the pedal crank arm of the bike and holds the pedal crank arm in a set rotational position. The pedal crank receiver is connected to a main shank of the bike rack, with the main shank extending longitudinally for supporting the weight of the bike from the receiver hitch. The bike rack also includes a second support structure connected to the main shank, which holds the bike at a location spaced from the pedal crank receiver.

### BRIEF DESCRIPTION OF THE DRAWINGS

FIG. 1 is a perspective view of a bicycle using a common frame style, considered part of the prior art with which the present invention can be used.

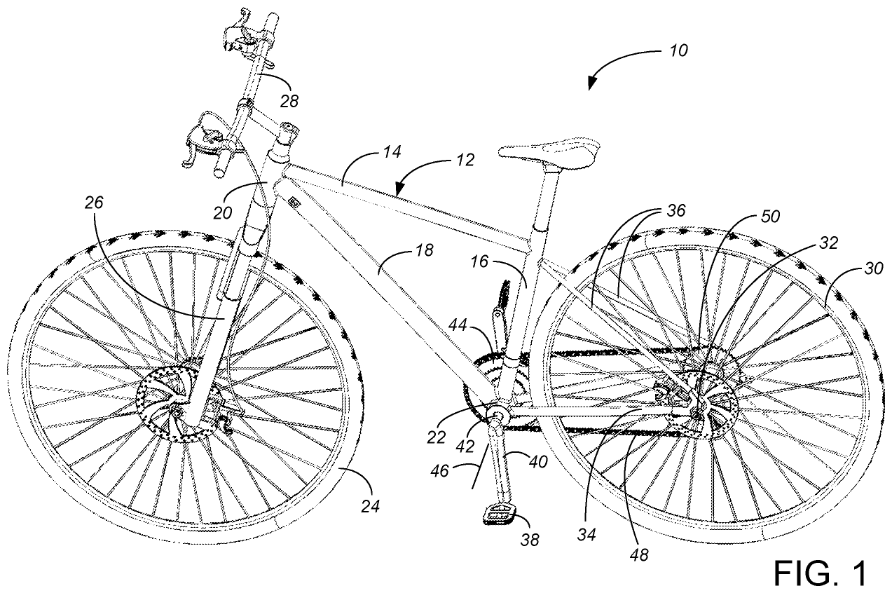

FIG. 2 is a perspective view from the upper-rear-right, of a first preferred embodiment of a vehicle mounted bike rack in accordance with the present invention, intended to be used with a quick mount adapter, shown supporting the bike of FIG. 1.

FIG. 3 is a perspective view from the upper-front-right, of the bike rack and bike of FIG. 2.

FIG. 4 is a perspective view from the upper-front-right, of the bike rack of FIGS. 2 and 3 without the bike.

FIG. 5 is a side view of the bike rack of FIGS. 2-4 without the bike.

FIG. 6 is a top view of the bike rack of FIGS. 2-5, shown with the arms in a folded, storage position.

FIG. 7 is a bottom view of the bike rack of FIGS. 2-6, shown with the arms in a folded, storage position.

FIG. 8 is a perspective view, from the upper-rear-right, of the two support posts, top cradles and pedal crank receivers of the bike rack of FIGS. 2-7.

FIG. 9 is an enlargement of the portion of FIG. 2 which secures around the pedal crank to hold the bike in position.

FIG. 10 is a perspective view from the upper-rear-right, of a second preferred embodiment of a vehicle mounted bike rack and quick mount adapter in accordance with the present invention, shown supporting a bike.

FIG. 11 is a perspective view from the upper-front-right, of the bike rack, quick mount adapter and bike of FIG. 10.

FIG. 12 is a rear elevational view of the bike rack, quick mount adapter and bike of FIGS. 10 and 11.

FIG. 13 is a rear elevational view of the bike rack of FIGS. 10-12, shown without the quick mount adapter and bike.

FIG. 14 is an enlargement of the portion of FIG. 10 which secures around the pedal crank to hold the bike in position.

FIG. 15 is a cross-section side elevational view of a portion of the bike rack which secures around the pedal crank to hold the bike in position, but showing the stabilizing bumper before it has been advanced and tightened down using the knob, taken along lines 15-15 in FIG. 12.

While the above-identified drawing figures set forth preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION OF THE PREFERRED EMBODIMENTS

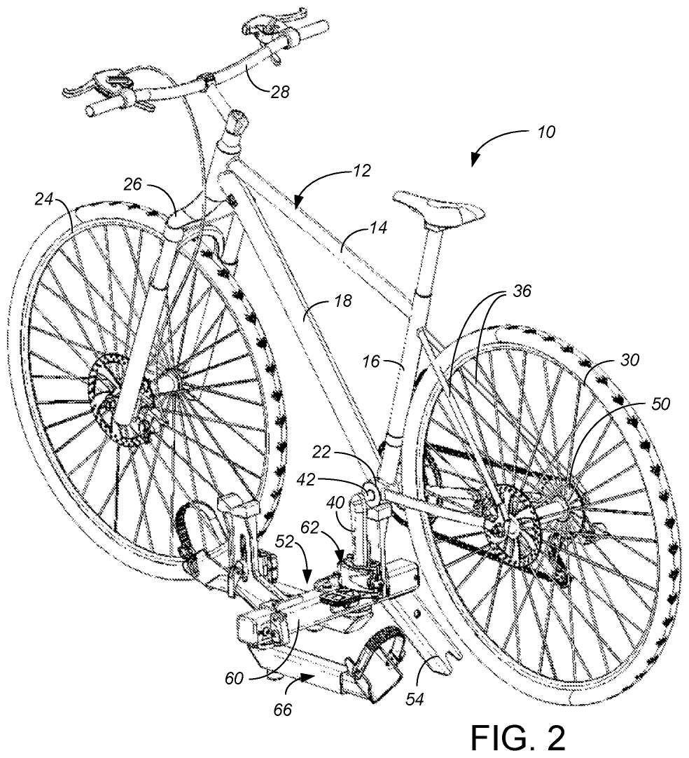

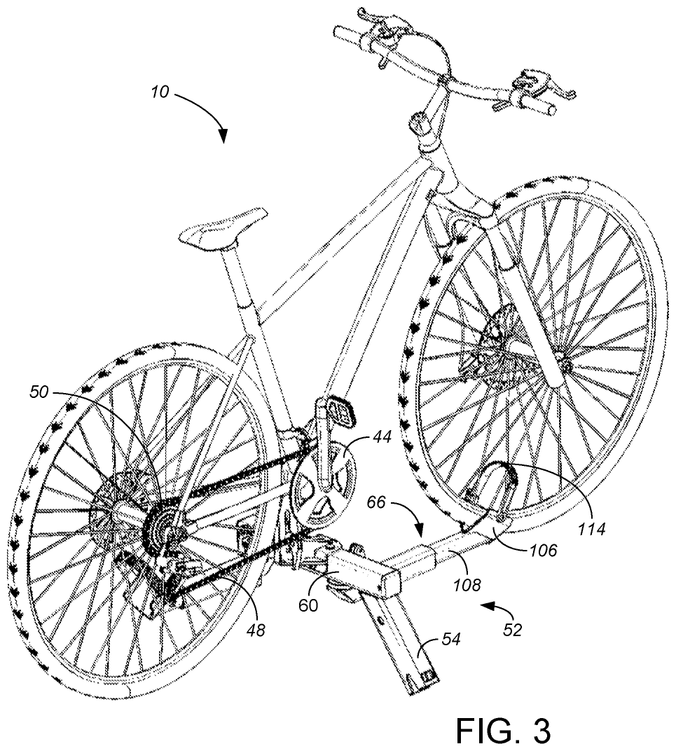

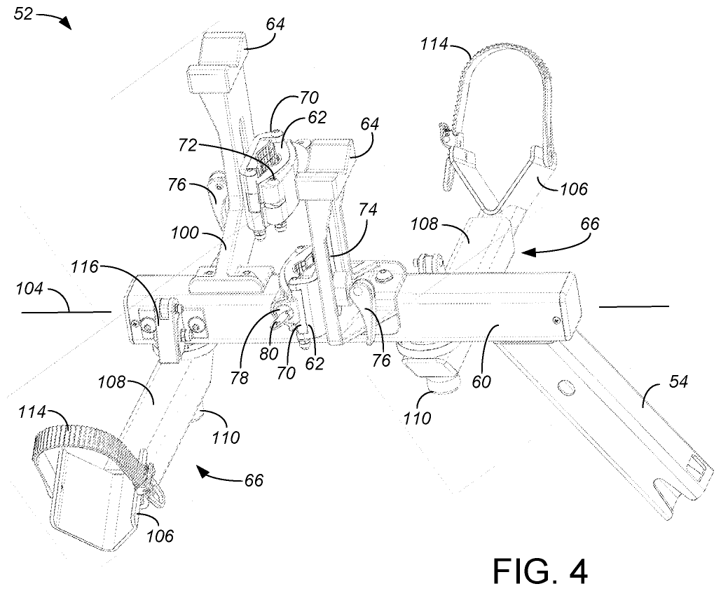

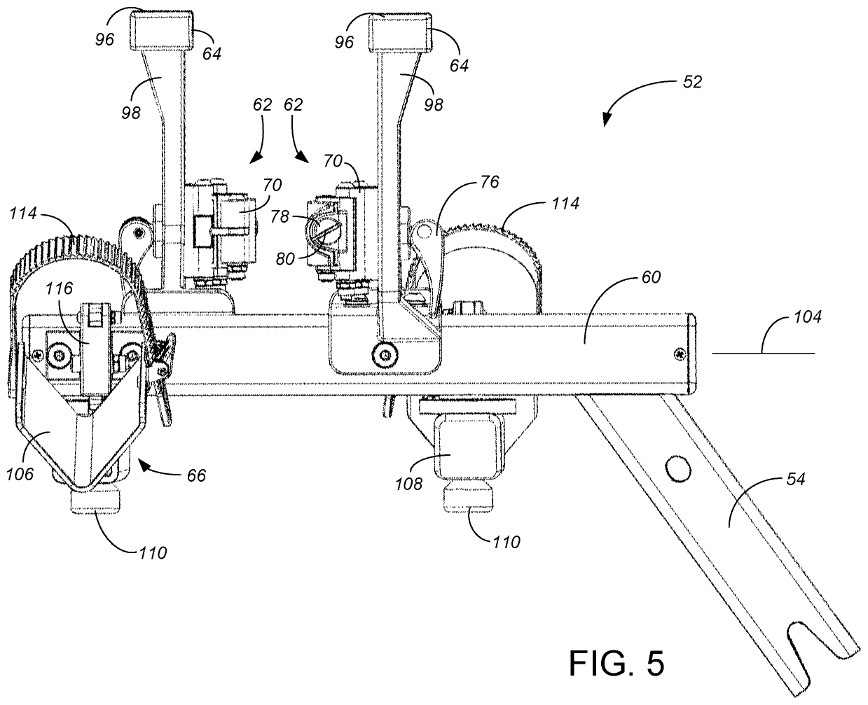

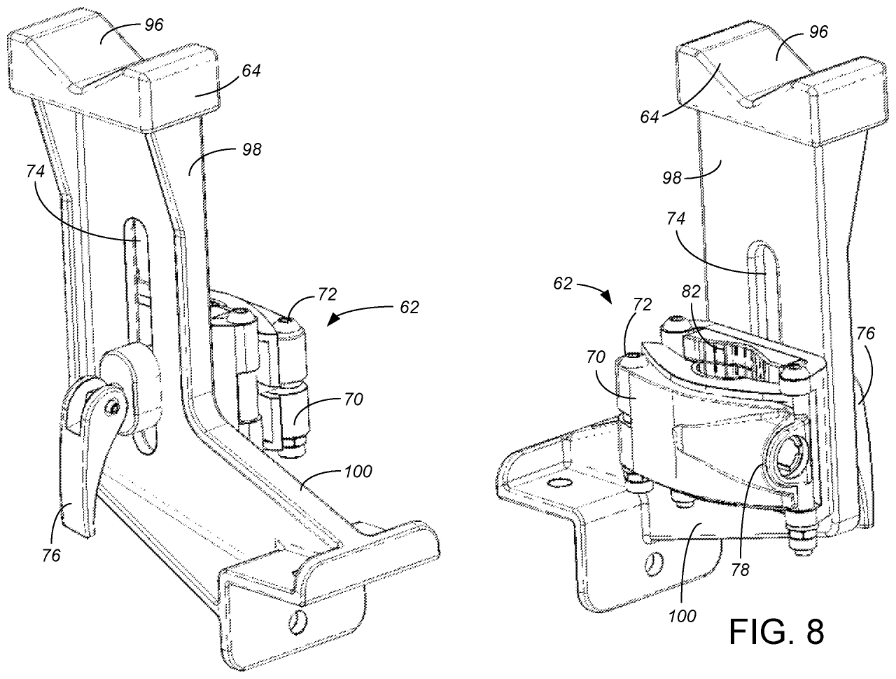

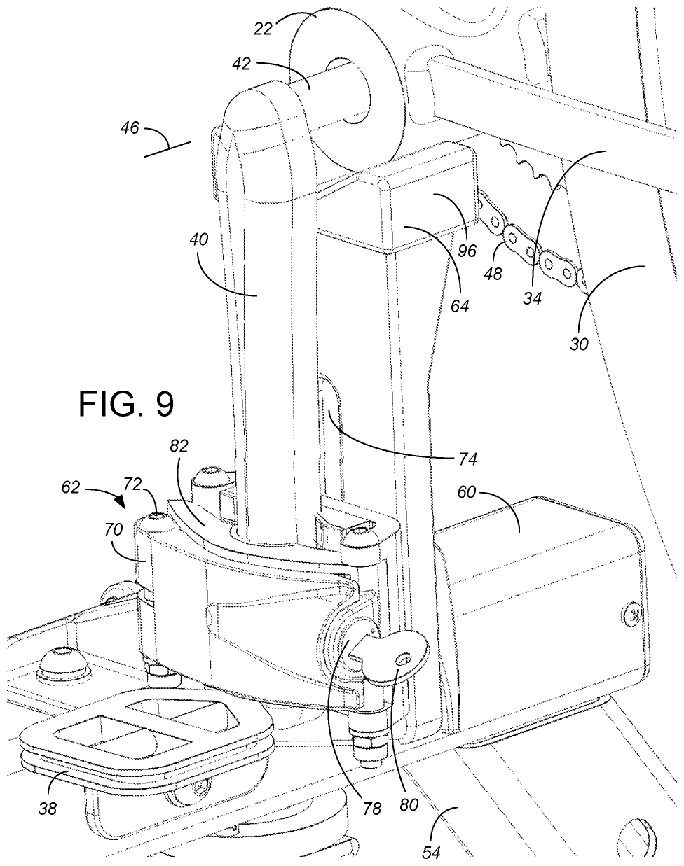

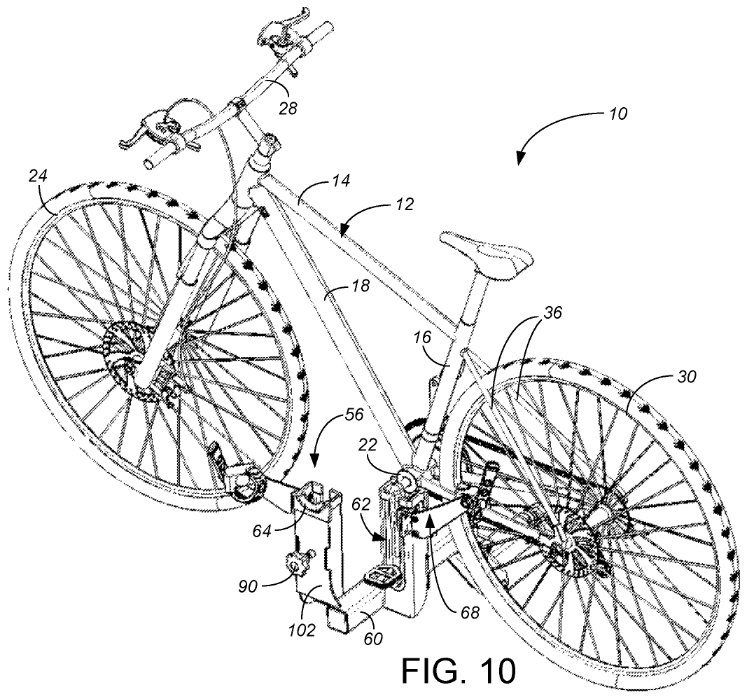

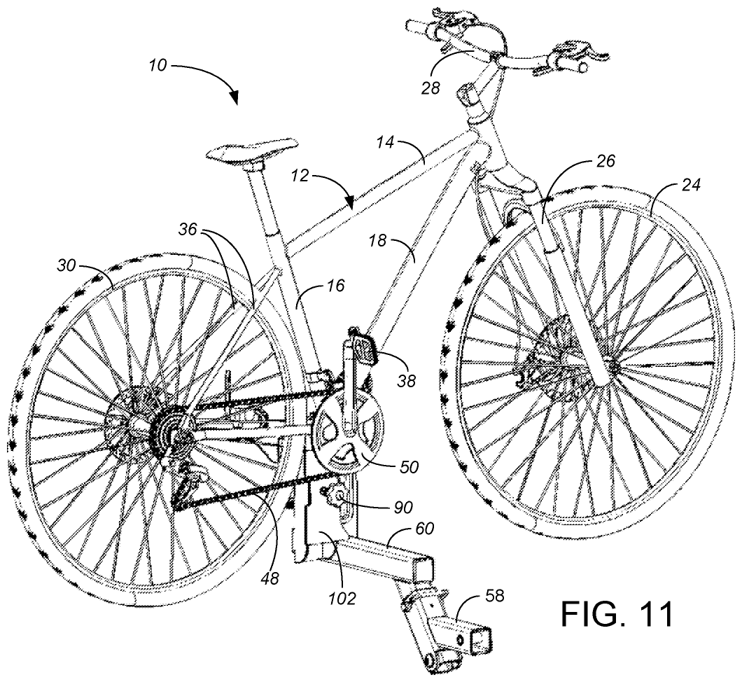

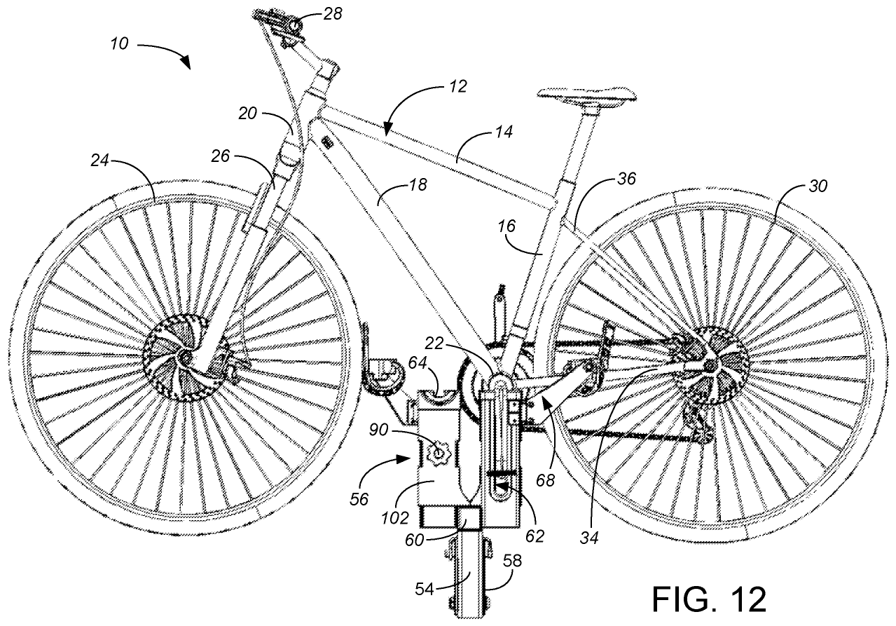

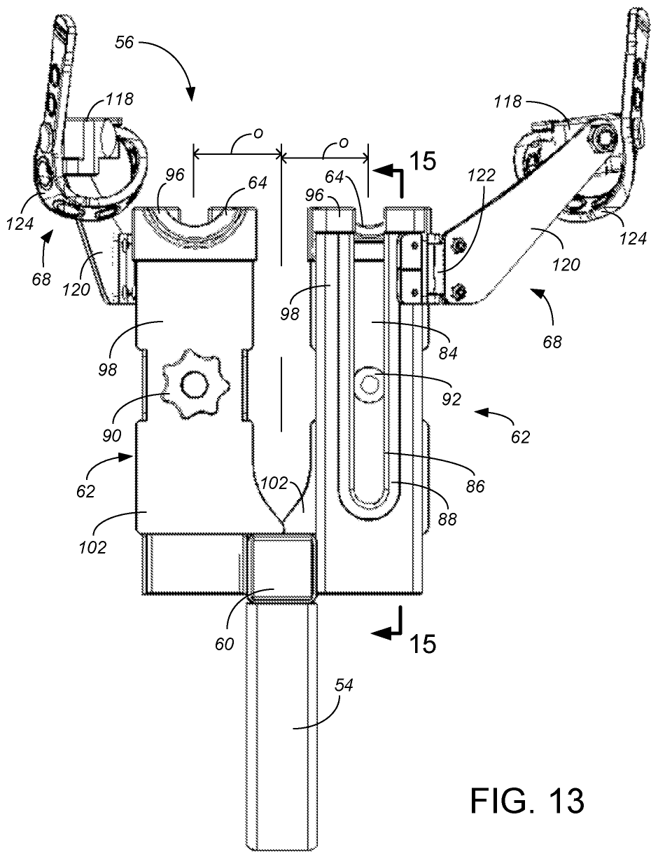

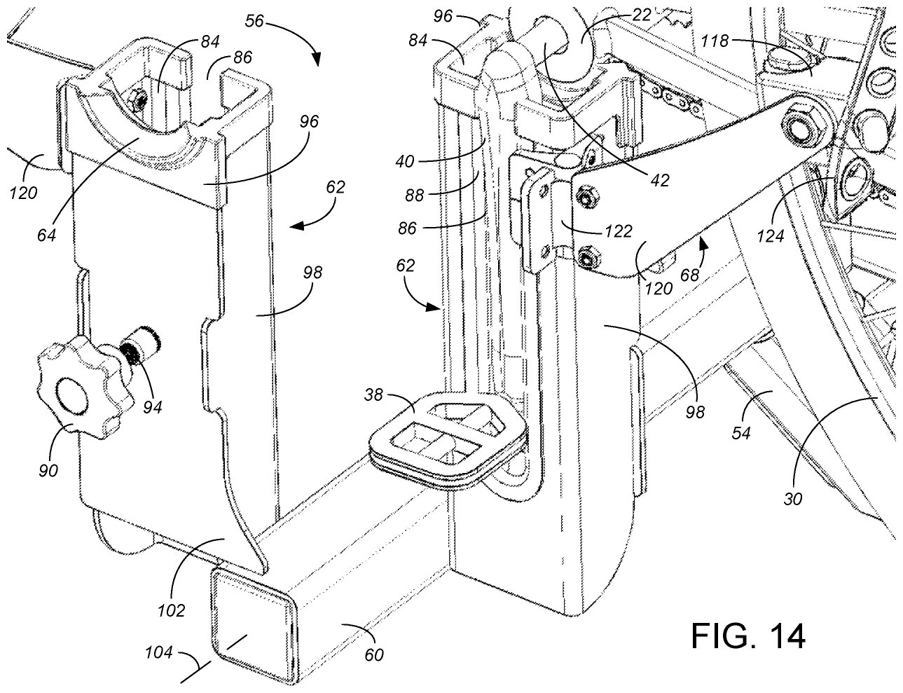

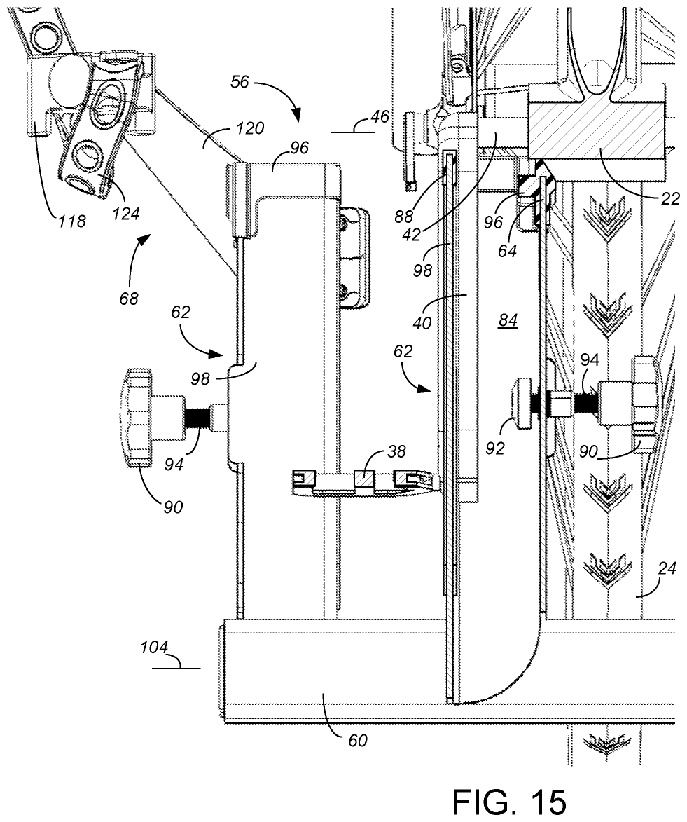

FIGS. 2-9 show a vehicle mounted bike rack 52 in accordance with a first preferred embodiment of the present invention. The leading end 54 (with directional terms such as “leading”, “trailing”, “horizontal”, “vertical”, “longitudinal”, “transverse”, “top”, “lower” etc., unless specifically referring to the bike 10, being defined in accordance with the direction and orientation of towing vehicle travel during use when mounted on the back of the towing vehicle) of the bike rack 52 is intended to be used with a quick mount adapter described in U.S. patent application Ser. No. ______, filed on even date herewith and incorporated by reference. FIGS. 10-15 show a vehicle mounted bike rack 56 in accordance with a second preferred embodiment of the present invention. The second embodiment 56 includes a substantially identical leading end 54 as the first embodiment 52, with FIGS. 11 and 12 showing the leading end 54 within the preferred quick mount adapter 58.

The preferred bike racks 52, 56 include a main shank 60 which extends generally horizontally and supports the weight of the bike(s) 10 in a cantilevered fashion off of the leading end 54/quick mount adapter 58 and therethrough off of the receiver tube (not shown) of the traditional receiver hitch (not shown) of the towing vehicle (not shown). The quick mount adapter 58 allows the bike rack 52, 56 to be quickly laid down for rear access (such as opening of a tailgate or rear door), and also allows the bike rack 52, 56 to be inverted (so the main shank 60 extends mostly vertically) to a stowage position when the bike rack 52, 56 is attached to the towing vehicle but not supporting a bike 10. Alternatively, the bike rack could be built with a traditional direct mount shank for a receiver hitch. The main shank 60 extends generally horizontal and in the fore-aft direction based on how the receiver tube of the hitch is mounted and oriented on the towing vehicle, for a length that allows sufficient spacing for the number of bikes 10 being supported. While the preferred embodiments each allow use with two bikes 10, other embodiments may be configured to hold only one bike or more than two bikes. While the preferred embodiments shown use a main shank 60 which is a metal tube with about 2×2 inch (51×51 mm) outer dimensions and a length of about 16 inches (410 mm) to support two bikes 10 sufficiently spaced from each other and from the back of the towing vehicle, other embodiments use a 1¼×1¼ inch (32×32 mm) main shank or a 2½×2½ inch (63×63 mm) main shank.

The present invention is a bike rack 52, 56 mountable from a traditional receiver hitch that utilizes at least one of the two pedal crank arms 40 of the bike 10 for securing and supporting the bike 10. While two pedal crank receivers could alternatively be used for each supported bike 10, the preferred embodiments include a single pedal crank receiver 62 (per bike 10) that allows tightening to the pedal crank arm 40. While other pedal crank positions could be used, the preferred pedal crank receivers 62 require the user to position the pedal crank 40 in a vertical, six-o-clock position prior to tightening the pedal crank receiver 62 around the pedal crank 40. Once tightened down, the pedal crank receiver 62 maintains the vertical orientation of the pedal crank 40. With most bicycles placing the chain and front and rear sprockets 44, 50 on the right hand side of the bike 10, the pedal crank receivers 62 preferably attach to the other (i.e., left) pedal crank 40 of the bike 10.

Beyond tightening down the pedal crank receiver 62 to hold the pedal crank 40 vertically, the bike rack 52, 56 must also contact the bike 10 in at least one additional location spaced from the pedal crank 40, to prevent the bike 10 from spinning around the pedal crank 40 about the axis 46. The preferred embodiments each contact the bike 10 in second and third locations spaced from the pedal crank 40. One of these locations, used in both embodiments shown, is a top cradle 64, with the bottom bracket shell 22 or pedal crank axle 42 of the bike 10 placed onto and into contact with the top cradle 64. In the first embodiment shown, the bike rack 52 also includes a wheel support 66, which connects to one (preferably the front) wheel of the bike 10 as a third support location. In the second embodiment shown in FIGS. 10-15, the bike rack 56 also includes a chainstay support 68, which connects to one of the chainstays 34.

The preferred pedal crank receiver 62 holds the pedal crank 40 in a vertical, six-o-clock position under and to the front or back (depending upon which direction, left or right on the towing vehicle, the bike 10 faces) of the top cradle 64. To best support the moments which are placed on the bike 10 during acceleration and deceleration of the towing vehicle, it is preferable to have the pedal crank receiver 62 attach to the pedal crank arm 40 as far as possible from the pedal crank axis 46 defined by the bottom bracket shell 22. It is possible to find crank lengths (distance from pedal axis to crank axis 46) within a range of about 6.5-7.1 inches (165-180 mm) in the bicycle market. Bottom bracket shells typically have a radius of about 0.6-1 inch (15-25 mm), and pedal axles will have a radius around 0.25 inches (6-8 mm), leaving only a distance in the range of about 5.25-6.25 inches (130-160 mm) to fit the attachment mechanism for the pedal crank receiver 62.

In the embodiment of FIGS. 2-9, the attachment mechanism for the pedal crank receiver 62 is a cammed and hinged, lockable clamp 70. The clamp 70 can be adjusted to change the width of the pedal crank arm opening, and then is tightened down around the pedal crank arm 40 by closing of the hinge 72 of the clamp 70. The clamp 70 is supported on a horizontal post riding in a vertical slot 74, and includes a cam 76 which can be hand tightened to secure the clamp 70 at any selected elevation along the slot 74. A lock 78 is provided, including a key 80, to hold the hinged clamp 70 closed on the pedal crank arm 40. The clamp 70 is mostly formed of steel, but preferably includes a plastic crank arm seat portion 82 that contacts the pedal crank arm 40. The plastic material of the crank arm seat portion 82 is softer than steel and helps to prevent marring and similar damage to the finished surface of the pedal crank arm 40. During use, the user simply places the bike 10 so it is supported by the top cradle 64, and then drops the hinged clamp 70 down so it rides in contact with the top of the pedal 38. The user then (in either order) tightens down the cam 76 to secure the elevation of the clamp 70 and tightens (if necessary) and closes the hinge clamp 70 around the pedal crank arm 40, thereafter locking the clamp 70 if desired. All of the tightening of the pedal crank receiver 62 is preferably done by hand and without any tools, as quickly accomplished as possible.

In the embodiment of FIGS. 10-15, the attachment mechanism for the pedal crank receiver 62 is a vertically-oriented central support channel 84 sized to receive the bike pedal crank arm 40. A vertical slot 86, large enough for the horizontal pedal axle but smaller than either the crank arm diameter or the pedal width or height, allows the bike 10 to be inserted vertically, with the pedal 38 sliding downward outside the channel 84 and the crank arm 40 inside the channel 84. In the preferred embodiment, a J-trim piece 88 extends downward to the sides defining the vertical slot 86. The J-trim 88 helps for smooth insertion and removal of the pedal crank arm 40 to and from the channel 84 without scratching or damage to the pedal crank arm 40, pedal axle or pedal 38. Opposite the vertical slot 86, a knob 90 allows screw tightening of a stabilizing bumper or plate 92 by moving the stabilizing bumper/plate 92 laterally within the channel 84 toward the pedal crank arm 40. Tightening of the knob 90 allows the user to stabilize the bike 10 and secure the pedal crank arm 40 into position. In the preferred embodiment, the knob 90 allows rotation of a threaded rod 94, advancing a rubber bumper 92 to press the crank 40 against the channel 84 for clamping. The vertical slot 86 needs to have a length sufficient below the top cradle 64 to account for the longest commonly used crank arms, and the tightening knob 90 is preferably positioned at a mid-height of the vertical slot 86. Tightening of the knob 90 and rubber bumper 92, by itself, may not provide sufficient securing force for the bike 10, and may present a compatibility issue with smaller diameter (round) crank profiles. The pedal crank arm 40 could potentially pass through the slot 86, and/or the pedal crank arm 40 could slip off of the rubber bumper 92. Accordingly, the clamp 70 is a more preferred securing structure. At a minimum, the embodiment of FIGS. 10-15 should have another attachment mechanism for securing the bike 10 beyond the central support channel 84 and rubber bumper 92, such as the chainstay support 68 or the wheel support 66 including a strap 114, discussed below. Another benefit of the embodiment of FIGS. 2-9 over the embodiment of FIGS. 10-15 is that the embodiment of FIGS. 10-15 require the left pedal 38 to be in the six o-clock position prior to lowering the bike 10 onto the top cradle 64, whereas in the embodiment of FIGS. 2-9 the left pedal 38 can be in any position during lowering of the bike 10 onto the top cradle 64 and then turned to the six o'clock position thereafter prior to clamping. Other clamping structures could alternatively be used.

In the preferred embodiments, the top cradle 64 includes a cover 96 formed of plastic, with a concave curved or wedged shape to support the curvature of the bottom bracket shell 22 or pedal crank axle 42. The plastic material of the top cradle cover 96 is softer than steel and supports the vertical load of the bike 10 without damaging the frame 12, including if the frame is formed of exotic materials such as carbon fiber. In the embodiment of FIGS. 10-15, the top cradle cover 96 integrally molded with the J-trim 88.

The top cradle 64 is located at the upper end of a support post 98. In the embodiment of FIGS. 2-9, the support post 98 is somewhat of an I-beam shape, including a lower side arm portion 100 extending horizontally. In the embodiment of FIGS. 10-15, the support post 98 is a rectangular tubular structure, with a flange 102 for welding to the right or left of the main shank 60. Positioning the top cradle 64 so the axis 46 of the bottom bracket shell 22 is offset by an offset distance o to the left or right of the main shank longitudinal axis 104 helps to avoid interference between adjacent pedals 38 of the two bikes 10, and gives more room for the tightening mechanism of the pedal crank receiver 62. In the preferred embodiment of FIGS. 2-9, the offset distance o is about 4.25 inches (110 mm), providing a total lateral offset 2*o of about 8.5 inches (220 mm) between the bottom bracket shell axes 46 of the two mounted bikes 10. In the preferred embodiment of FIGS. 10-15, the offset distance o is about 2.5 inches (60 mm), providing a total lateral offset 2*o of about 5 inches (120 mm) between the bottom bracket shell axes 46 of the two mounted bikes 10.

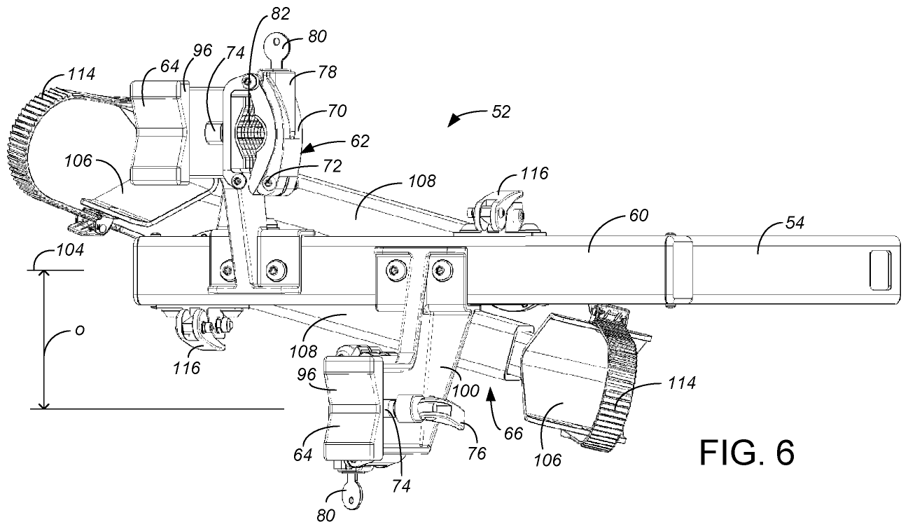

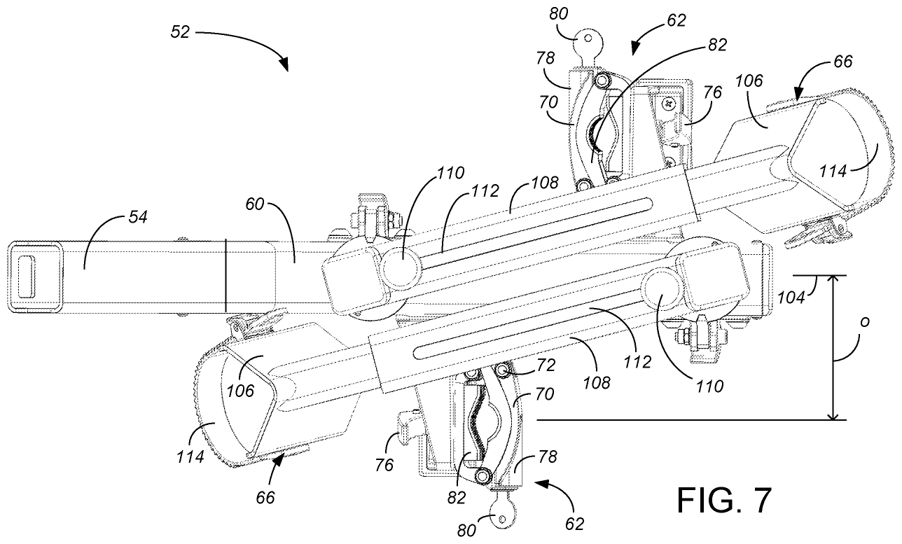

In the embodiment of FIGS. 2-9, in addition to the pedal crank receiver 62 and the top cradle 64, the rack 52 contacts the bike 10 in a third location of one of the wheels 24, 30, preferably the front wheel 24, with the wheel support 66. The wheel support 66 includes a wheel tray 106 extends on an end of a support arm 108 off of the main shank 60. If desired, the wheel tray 106 can have a hinged connection to the support arm 108, so it can be placed at an orientation matching the wheel tangent regardless of wheel diameter and spacing on the bike 10 and regardless of elevation of the bottom bracket shell 22 above the ground on the bike 10. Alternatively, the wheel tray 106 can be rigidly secured such as by welding to the end of the support arm 108. If desired, the support arm 108 can be a telescoping structure so as to allow it to extend or retract to the length necessary to match the distance from the bottom bracket shell 22 to the wheel 24 for any given bike. A length setting handknob 110 is provided, which can be screw-tightened by hand to secure the length of the telescoping structure of the support arm 108. While the length setting handknob 110 could be a set screw threaded through the outer tube and digging into the inside tube of the telescoping structure 108, the preferred length setting handknob 110 is threaded into the inside tube and rides in a bottom slot 112 (shown in FIG. 7) of the outer tube, allowing a user-selected length of the support arm 108 anywhere in a range of about 11 to 18 inches (280 to 460 mm) from the longitudinal axis of the main shank 60. A flexible strap 114 on a top of the wheel tray 106 can be positioned between wheel spokes and attached to prevent wheel rotation during towing. As best shown by the folded configuration shown in FIGS. 6 and 7, the support arm 108 is preferably hinged to the main shank 60, so the support arm(s) 108 can be moved between an outwardly-directed, usage position and a folded, storage position. A separate cam mechanism 116 can be tightened to secure the support arm 108 in the outwardly-directed, usage position.

In the embodiment of FIGS. 10-15, in addition to the pedal crank receiver 62 and the top cradle 64, the rack 56 contacts the bike 10 in a third location of one of the chainstays 34, preferably the left chainstay 34. This embodiment includes a chainstay cradle 118 mounted on the end of a pivot arm 120, angling away from the support post 98. The distal end of the pivot arm 120 can be secured to the chainstay 34 of the bike frame 12, preventing rotation of the bike 10 during transport both about the generally vertical axis defined by the crank arm 40 in the crank arm channel 84 and about the generally horizontal crank axis 46 through the bottom bracket shell 22. The fact that the The pivot arm 120 includes a hinge 122 for pivoting about a generally vertical hinge axis, which hinge 122 is secured at any of two or more user-selectable elevations on the rack 56. The vertical adjustment of the pivot arm 40 allows the angle of each bike 10 about the horizontal axis 46 through the bottom bracket shell 22 to be adjusted as required to avoid interference when a second bike 10 is added to the rack 56. The hinge 122 is preferably a friction hinge which will hold its position making loading and unloading of the bike 10 easier. The hinge pivoting allows for wider (particularly common for fat tire bikes) or narrower chainstays, and also allows for some adjustment of the orientation of the bike 10 about the vertical axis defined by the pedal crank arm 40 as required to avoid interference when a second bike 10 is added to the rack 56.

The preferred chainstay cradle 118 has a downwardly exposed notch which rides on top of the chainstay arm 34. The chainstay cradle 118 includes a rubber strap 124 which can be flexed or wrapped around the chainstay 34 and then attached back to the chainstay cradle 118 so the chainstay arm 34 is kept in engagement with the cradle 118. After the rubber strap 124 has been wrapped around the chainstay arm 34 and had one of the openings along its length secured to the cradle 118, the distal end of the rubber strap 124 can extend further away from the cradle 118 to help prevent rotation of the wheel/tire during towing. Other clamping methods could alternatively be used, particularly for the third contact location on the bike 10. Even with other clamping methods, the substantial entirety of the weight of the bike 10 is still preferably supported by the pedal crank receiver 62 and/or the bottom bracket shell cradle 64.

All of these illustrated and discussed embodiments are light in weight and are simpler and lower in cost than many prior art designs. Use is easy, merely by rotating the bike's pedal 38 downward to the correct vertical orientation, and then lifting and dropping the bike 10 into position prior to securing the tray 106 or support arm 120 to the bike 10.

Although the present invention has been described with reference to preferred embodiments, workers skilled in the art will recognize that changes may be made in form and detail without departing from the spirit and scope of the invention. In particular, all of the dimensions and materials, unless included in the claims, are exemplary only.

1. A bike rack mountable from a receiver hitch of a towing vehicle, comprising:
a main shank for supporting the weight of a bike; and
a pedal crank receiver connected to the main shank, the pedal crank receiver being adapted to tighten to a pedal crank arm of the bike and hold the pedal crank arm in a set rotational position; and
a second support structure connected to the main shank, for securing the bike at a location spaced from the pedal crank receiver.

2. The bike rack of claim 1, further comprising a cradle for supporting a bottom bracket shell or pedal crank axle of the bike, with the pedal crank arm rotatable about a generally horizontal pedal crank axis defined by the bottom bracket shell during driving of the bike, the cradle having a cradle cover formed of a softer material than steel.

3. The bike rack of claim 2, wherein the pedal crank arm is a left pedal crank arm of the bike, and wherein the pedal crank receiver holds the left pedal crank arm of the bike at a six-o'clock position vertically below the bottom bracket shell.

4. The bike rack of claim 3, wherein the pedal crank receiver is mounted to a support post for the cradle at a vertically adjustable position.

5. The bike rack of claim 2, wherein the cradle is at a top of a support post extending upwardly from the main shank.

6. The bike rack of claim 2, wherein the second support structure is a wheel support extending from the main shank for holding a wheel of the bike, the wheel support having a strap which wraps around the wheel and through openings between spokes of the wheel.

7. The bike rack of claim 2, wherein the second support structure is a chainstay support extending from the main shank for holding a chainstay of the bike.

8. The bike rack of claim 2, wherein the pedal crank axis is laterally offset from a longitudinal axis of the main shank.

9. The bike rack of claim 1, wherein the pedal crank receiver is hinged around the pedal crank.

10. The bike rack of claim 9, wherein the pedal crank receiver comprises a cam for tightening a hinge around the pedal crank.

11. The bike rack of claim 1, wherein the pedal crank receiver comprises a lock for locking the pedal crank receiver in a tightened position around the pedal crank.

12. The bike rack of claim 1, wherein the pedal crank receiver comprises a vertically oriented slot for receiving a pedal post on a distal end of the pedal crank arm.

13. The bike rack of claim 1, wherein the pedal crank receiver comprises a horizontally-oriented screw for screw tightening onto the pedal crank.

14. The bike rack of claim 1, wherein the second support structure is a wheel support extending from the main shank for holding a wheel of the bike, the wheel support having a strap which wraps around the wheel and through openings between spokes of the wheel.

15. The bike rack of claim 1, wherein the second support structure is a chainstay support extending from the main shank for holding a chainstay of the bike.

16. The bike rack of claim 1, wherein the main shank extends horizontally under the bike, and wherein the second support structure is at a distal end of a second support arm, the second support arm having a pivotal connection relative to the main shank that allows the second support arm to pivot about a generally vertical pivot axis.

17. A method of mounting a bike from a receiver hitch of a towing vehicle, comprising:
attaching a bike rack to the receiver hitch of the towing vehicle, the bike rack having a main shank for supporting the weight of a bike;
tightening a pedal crank receiver to a pedal crank arm of the bike, thereby holding the pedal crank arm in a set rotational position, the pedal crank receiver being connected to the main shank; and
securing a second support structure to the bike at a location spaced from the pedal crank receiver, the second support structure being connected to the main shank.

18. The method of claim 17, further comprising placing the bike on a cradle for supporting a bottom bracket shell or pedal crank axle of the bike, with the pedal crank arm rotatable about a generally horizontal pedal crank axis defined by the bottom bracket shell during driving of the bike the cradle having a cradle cover formed of a softer material than steel.

19. The method of claim 17, wherein the second support structure is a wheel support extending from the main shank for holding a wheel of the bike, the wheel support having a strap which wraps around the wheel and through openings between spokes of the wheel.

20. The method of claim 17, wherein the second support structure is a chainstay support extending from the main shank for holding a chainstay of the bike.
